(19) United States
(12) Patent Application Publication
(10) Pub. No.: US 2013/0191629 A1
(43) Pub. Date: Jul. 25, 2013

(54) SECURE GROUP-BASED DATA STORAGE IN THE CLOUD

(71) Applicants: James J. Treinen, Superior, CO (US); Adam R. Younce, Boulder, CO (US)

(72) Inventors: James J. Treinen, Superior, CO (US); Adam R. Younce, Boulder, CO (US)

(73) Assignee: LACONIC SECURITY, LLC, Boulder, CO (US)

(21) Appl. No.: 13/738,808

(22) Filed: Jan. 10, 2013

Related U.S. Application Data
(60) Provisional application No. 61/588,543, filed on Jan. 19, 2012.

(51) Int. Cl. H04L 9/08

(52) U.S. Cl. CPC H04L 9/08
USPC 713/153

(57) ABSTRACT

Methods of securely storing documents electronically for access by members of a workgroup, methods of changing membership in the workgroup, and systems for providing secure data storage for a workgroup of changeable membership. Various embodiments use an encrypting vault key for a workgroup to encrypt the data files or session keys, and then encrypt the decrypting vault key, which corresponds with the encrypting vault key, using the public key of each member of the workgroup. If the workgroup membership is changed, the decrypting vault key can be re-encrypted with the public keys of each member of the workgroup without needing to download or re-upload the encrypted files associated with that workgroup. Other embodiments are disclosed.

### CROSS-REFERENCE TO RELATED APPLICATIONS

This application claims the benefit of U.S. Provisional Application No. 61/588,543, filed Jan. 19, 2012. U.S. Provisional Application No. 61/588,543 is incorporated herein in its entirety.

### FIELD OF THE INVENTION

This invention relates generally to security of computer data. Particular embodiments include encrypted storage in the cloud.

### BACKGROUND

With the advent of “cloud” computing, many companies are moving their information technology (IT) infrastructures from private data centers to cloud-based service providers. Cloud-based service providers provide fully hosted IT solutions that can drastically reduce data center costs by hosting multiple customers on a single shared infrastructure. Because the infrastructure is shared, there can be significantly more risk associated with the provider's ability to keep their customers' data secure. Various approached to these concerns provide encryption services so that the customers' data is encrypted, for example, both in transmission and at rest. Protection of data in transit is generally accomplished using cryptographic communication protocols, such as Secure Socket Layer (SSL) or Transport Layer Security (TLS).

Some approaches to securing data at rest use a symmetric encryption scheme, such as Advanced Encryption Standard (AES). AES and similar symmetric encryption algorithms require the use of a shared secret key. When encryption of the data is performed by the cloud-based service provider, the provider has access to the shared key and to the customers' data. The service provider stores the encryption keys in a centralized key store. Although the customers' data is stored in encrypted form, it is vulnerable to attackers who may compromise the service provider's key store and obtain access to the encryption keys.

Other approaches to securing data at rest use a public key cryptography scheme (also referred to as an asymmetric encryption scheme), such as the RSA algorithm, which uses a public-private key pair. In various approaches, the public key is used to encrypt the data, and the private key is used to decrypt the data. In other approaches, as is set forth in the OpenPGP standard (RFC 4880), the data is encrypted with a symmetric “session” key using a symmetric encryption algorithm, and the session key is encrypted with the public key using an asymmetric encryption algorithm. The private key may then be used to decrypt the session key, which in turn may be used to decrypt the data. For workgroups, each member of the workgroup has a public-private key pair. After encrypting a data file with a session key, the session key is encrypted with each member's public key. Each encrypted session key is then attached to the encrypted data file. The document may be stored a cloud-based service provider's bulk storage. Each member of the workgroup thus has the ability to decrypt the session key using the member's private key, and the session key may be used to decrypt the data file.

When membership of the workgroup changes, the administrator of the workgroup must download the entire set of documents encrypted for that workgroup and decrypt the session key and/or data files. The workgroup administrator must then re-encrypt the data file and/or session key using the public keys of each member of the new workgroup, then re-upload the documents to the cloud. There are several drawbacks to this approach. First, this process requires extensive time and computing resources from the workgroup administrator. Second the process requires extensive time and computing resources from the cloud-based service provider. Some cloud-based service providers charge not only for storage space, but also charge for computing resources, and in many cases provide bandwidth and processor usage as metered services. Updating the workgroup's documents after each membership change may thus be costly, and in some cases, cost-prohibitive.

In some approaches, the decryption and re-encryption process that is required upon changed membership of the workgroup is performed by the cloud-based service provider, thus eliminating the need for the workgroup administrator to download and re-upload the documents. Such approaches require, however, that the cloud-based service provider have access to a workgroup member's private key in order to decrypt the session key and/or data files. There is thus a potential risk of an attacker exploiting weaknesses in a cloud-based service provider's infrastructure to obtain access to the private key, the decrypted session key, and/or the decrypted data files. Based on these security concerns, many companies and individuals are reticent to take advantage of the potential cost savings that may be obtained by using cloud-based services.

Accordingly, a need or potential for benefit exists for an apparatus, system, or method that addresses one or more of the problems or shortcomings noted above.

### SUMMARY OF PARTICULAR EMBODIMENTS OF THE INVENTION

Various embodiments of the present inventions partially or fully address or satisfy one or more of the needs, potential areas for benefit, or opportunities for improvement described herein, or known in the art, as examples. In certain embodiments, for instance, data files, session keys, and private keys are unencrypted only on a member's endpoint device, thus preventing the cloud-based service provider or any attacker of the cloud-based service provider from accessing the unencrypted data files or the keys necessary to ultimately decrypt the encrypted data files.

Various embodiments utilize an additional layer of cryptography to allow a workgroup administrator to change the membership of a workgroup without the need to download or re-upload the encrypted data files associated with that workgroup. A workgroup may include one or more individuals, and the files associated with each workgroup are part of that workgroup's vault. In a number of embodiments, rather than encrypting a session key or data file using the public key of each member of a workgroup, an encrypting key for the vault is used to encrypt the session key or data file. The decrypting key for the vault, which corresponds to the encrypting key for the vault, is then encrypted, in various embodiments, using the public key of each member of the workgroup. If the workgroup membership is changed, the decrypting vault key can be decrypted using a private key of a workgroup member, and the encrypting vault key can then be re-encrypted with the public keys of each member of the workgroup, as examples. Such embodiments can save time and computing resources, in a number of embodiments, and reduce metered bandwidth and processing usage expenses on cloud-based service providers. Benefits of various embodiments of the invention exist over the prior art in these and other areas that may be apparent to a person of ordinary skill in the art having studied this document. These and other aspects of various embodiments of the present invention may be realized in whole or in part in various embodiments as shown, described, or both, in the figures and related descriptions herein.

Specific embodiments of the invention provide various methods of securely storing documents electronically for access by members of a workgroup. Such a method can include, for example, at least certain acts. Such acts can include, for instance, acts of using at least one computer, encrypting the documents with a first key for a vault to produce encrypted documents, and electronically storing the encrypted documents on at least one computer through a computer network. Such acts also include, in some embodiments, acts of encrypting a second key for the vault that corresponds to the first key for the vault using each workgroup member's personal public key to produce an encrypted second key for the vault, and electronically storing the encrypted second key for the vault on at least one computer through the computer network. Such a method can further include, for example, upon request from a member of the workgroup, an act of providing, through the computer network, the encrypted documents and the encrypted second key for the vault to the member of the workgroup. The member of the workgroup can then decrypt the encrypted second key for the vault using a personal private key for the member, which corresponds to the member's personal public key. The member of the workgroup can then decrypt the encrypted documents using the second key for the vault. Such a method can also include, in some embodiments, when membership of the workgroup changes and produces changed membership, an act of downloading the encrypted second key for the vault and re-encrypting the second key for the vault with each of the changed membership's personal public keys.

In some such methods, the first key for the vault is a public key, and the act of encrypting the documents with the first key for the vault includes encrypting the documents with the public key for the vault to produce the encrypted documents. Moreover, in some embodiments, the second key for the vault is a private key that corresponds to the first key for the vault, and the act of encrypting the second key for the vault using each workgroup member's personal public key to produce an encrypted second key for the vault includes encrypting the private key for the vault that corresponds to the public key for the vault using each workgroup member's personal public key to produce an encrypted private key for the vault.

In other such methods, the first key for the vault is a symmetric key, and the act of encrypting the documents with the first key for the vault includes encrypting the documents with the symmetric key for the vault to produce the encrypted documents. Furthermore, in some embodiments, the second key for the vault is the first key for the vault, and the act of encrypting the second key for the vault using each workgroup member's personal public key to produce an encrypted second key for the vault includes encrypting the symmetric key for the vault using each workgroup member's personal public key to produce an encrypted symmetric key for the vault.

In other specific embodiments, the invention provides a method of securely storing computer files for access by members of a workgroup. In a number of such embodiments, at least part of the method is implemented via execution of computer instructions configured to run at one or more processing modules and configured to be stored at one or more non-transitory memory modules. Further, in various embodiments, the method includes (e.g., in any order except where a particular order is explicitly indicated), at least the acts of executing a set of one or more computer instructions to generate a base symmetric key, and executing a set of one or more computer instructions to encrypt a base computer file using the base symmetric key and a symmetric encryption algorithm, thus producing an encrypted computer file. A number of such methods further include executing a set of one or more computer instructions to encrypt the base symmetric key using a first key for a vault, thus producing an encrypted symmetric key, and executing a set of one or more computer instructions to save the encrypted computer file and save the encrypted symmetric key. Such methods further include executing a set of one or more computer instructions to, for each member of a workgroup, encrypt a second key for the vault, which corresponds to the first key for the vault, using a public key of the member, thus producing an encrypted second key for the vault, and executing a set of one or more computer instructions to save the encrypted second key for the vault using at least one network.

In some such embodiments, the method includes the act of executing a set of one or more computer instructions to attach the encrypted symmetric key to the encrypted computer file. Moreover, in particular embodiments, the act of executing the set of one or more computer instructions to save the encrypted computer file and save the encrypted symmetric key includes executing a set of one or more computer instructions to save the encrypted computer file with the encrypted symmetric key attached.

In a number of embodiments, the method further includes at least certain other acts. Such acts may include executing a set of one or more computer instructions to decrypt the encrypted second key for the vault using a private key of the member. Such acts also include, in a number of embodiments, executing a set of one or more computer instructions to decrypt the encrypted symmetric key using the second key for the vault. Such a method also includes, in a various embodiments, executing a set of one or more computer instructions to decrypt the encrypted computer file using the base symmetric key.

In some embodiments, the method further provides a process of changing membership of the workgroup. The method includes (e.g., in any order) at least the acts of executing a set of one or more computer instructions to decrypt the encrypted second key for the vault using a workgroup administrator's private key, and executing a set of one or more computer instructions to add a new member to the workgroup. A number of such methods further include an act of executing a set of one or more computer instructions to re-encrypt the second key for the vault using the public key of each member of the workgroup, including the new member, thus producing a new encrypted second key for the vault. Some embodiments of such methods also include an act of executing a set of one or more computer instructions to save the new encrypted second key for the vault using at least one computer network.

In a number of embodiments, the method also provides another process of changing membership of the workgroup. The method includes (e.g., in any order) at least the acts of executing a set of one or more computer instructions to decrypt the encrypted second key for the vault using a workgroup administrator's private key, and executing a set of one or more computer instructions to subtract an old member from the workgroup. In some embodiments, the method further includes the act of executing a set of one or more computer instructions to re-encrypt the second key for the vault using the public key of each member of the workgroup, not including the old member, thus producing a new encrypted second key for the vault. A number of such methods also include an act of executing a set of one or more computer instructions to save the new encrypted second key for the vault using at least one computer network.

Other specific embodiments of the invention provide a system for providing secure data storage. In a number of embodiments, for instance, the system includes a server component, running on at least one web server, that hosts web services backed by databases. The server component, for example, can perform user authentication, key management, and maintenance of information regarding the location of user owned encrypted files for multiple users that are members of at least one vault that houses the encrypted files. Further, in many of these embodiments, the system includes client software, that, when installed on a user computer, handles cryptographic actions, workgroup management actions, and storage and retrieval actions, as examples. Moreover, in a number of embodiments, the system includes, for example, a connection to a network-based bulk data-storage system, and an administrative web portal that manages each user's account information.

In some such embodiments, the client software includes, for example, an encryption module that encrypts files of the workgroup using a first key for the vault. Moreover, in certain embodiments, the encryption module further encrypts a second key for the vault that corresponds to the first key for the vault using the personal public key of each member of the workgroup, thus producing an encrypted second key for the vault, so each member of the workgroup can download and decrypt the encrypted second key for the vault and use the second key for the vault to decrypt the files of the workgroup. Furthermore, in a number of embodiments, the encryption module further uses a personal private key of a member of the workgroup, which corresponds to the personal public key of the member, to decrypt the encrypted second key for the vault and uses the second key for the vault to decrypt the encrypted files of the workgroup.

In other such embodiments, the client software includes, for instance, an encryption module that generates a base symmetric key and encrypts a base computer file using the base symmetric key and a symmetric encryption algorithm, thus producing an encrypted computer file. Further, the encryption module, for example, encrypts the base symmetric key using a first key for the vault, thus producing an encrypted symmetric key. Moreover, in a number of embodiments, the encryption module, for each member of the workgroup, encrypts a second key for the vault, which corresponds to the first key for the vault, using a personal public key for the member, thus producing an encrypted key for the vault.

In some such embodiments, the encryption module also, for example, decrypts the encrypted second key for the vault using a personal private key for the member, which corresponds to the personal public key for the member. Additionally, in certain embodiments, the encryption module also decrypts the encrypted symmetric key using the second key for the vault. Moreover, the encryption module, for instance, decrypts the encrypted computer file using the base symmetric key. In certain further embodiments, the encryption module also decrypts the encrypted second key for the vault using a workgroup administrator's personal private key. Furthermore, in particular embodiments, the encryption module, for each member of a changed workgroup, re-encrypts the second key for the vault using the personal public key for the member, thus producing a new encrypted second key for the vault. Even further, in a number of embodiments, the encryption module further electronically stores the encrypted second key for the vault to the server component using at least one computer network.

In a number of such embodiments, the client software includes a file synchronization module that, for instance, attaches the encrypted symmetric key to the encrypted computer file, and electronically stores the encrypted computer file with the encrypted symmetric key attached to the network-based data-storage system using at least one computer network. In some embodiments, the first key for the vault is a public key for the vault, the second key for the vault is a private key for the vault that corresponds to the public key for the vault, and the encrypted second key for the vault is an encrypted private key for the vault. In other embodiments, the first key for the vault is a symmetric key for the vault, and the second key for the vault is the first key for the vault.

In addition, various other embodiments of the invention are also described herein, and other benefits of certain embodiments may be apparent to a person of ordinary skill in the art.

### BRIEF DESCRIPTION OF THE DRAWINGS

To facilitate further description of the embodiments, the following drawings are provided in which:

FIG. 1 is a block diagram illustrating an example of a system for providing secure data storage;

FIG. 2 is a flow chart illustrating an example of a method of securely storing documents for access by members of a workgroup;

FIG. 3 is a flow chart illustrating an example of a method of securely storing files for access by members of a workgroup;

FIG. 4 is a front elevational view illustrating an example of a computer that is suitable for implementing an embodiment of a user computer and/or one or more of the elements of the system of FIG. 1; and

FIG. 5 is a block diagram illustrating an example of the elements included in the circuit boards inside a chassis of the computer of FIG. 4.

For simplicity and clarity of illustration, the drawing figures illustrate the general manner of construction, and descriptions and details of well-known features and techniques may be omitted to avoid unnecessarily obscuring the invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

### DETAILED DESCRIPTION OF EXAMPLES OF EMBODIMENTS

A number of embodiments of the subject matter described herein include computer-implemented methods of securely storing documents electronically for access by members of a workgroup, methods for changing membership in the workgroup, and systems for providing secure data storage for a workgroup of changeable membership. Various embodiments use an encrypting vault key for a workgroup to encrypt the data files or session keys, and then encrypt the decrypting vault key, which corresponds with the encrypting vault key, using the public key of each member of the workgroup. If the workgroup membership is changed, the decrypting vault key can be re-encrypted with the public keys of each member of the workgroup without needing to download or re-upload the encrypted files associated with that workgroup.

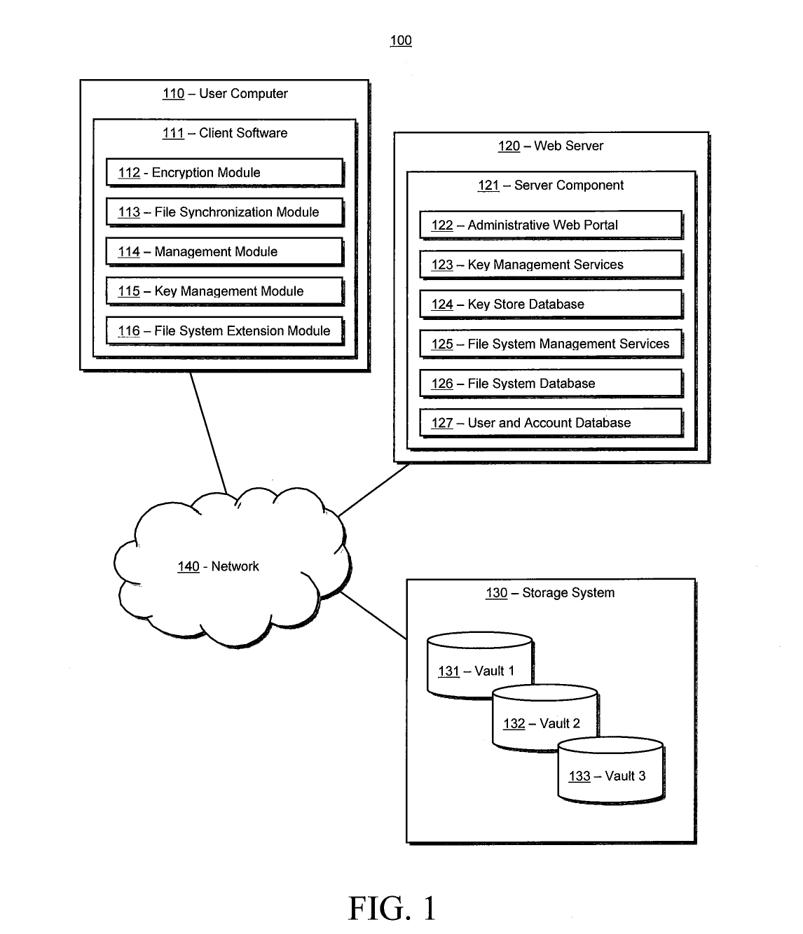

FIG. 1 illustrates, for example, system 100 for providing secure data storage.

System 100 is merely exemplary and the scope of the invention is not limited to the particular embodiments presented herein. The invention can be employed in many different embodiments or examples not specifically depicted or described herein. In some embodiments, certain elements or modules of system 100 can perform various procedures, processes, and/or acts. In other embodiments, the procedures, processes, and/or acts can be performed by other suitable elements or modules of system 100. In the embodiment illustrated, system 100 includes server component 121, running on at least one web server 120, that hosts web services, such as key management services 123 and file system management services 125, backed by databases, such as key store database 124, file system database 126, and user and account database 127. In other embodiments, the various services and databases may be distributed across multiple server components 121, multiple web servers 120, or other servers or computers. Server component 121, for example, can perform user authentication, key management, and maintenance of information regarding the location of user owned encrypted files for multiple users that are members of at least one vault that houses the encrypted files. System 100 also includes, for instance, client software 111, that, when installed on user computer 110, handles cryptographic actions, workgroup management actions, and storage and retrieval actions. System 100 can, in various embodiments, have multiple user computers 110, each with client software 111, and containing various modules. In some embodiments, user computer 110 can be a desktop computer, laptop computer, smart phone, tablet, or other endpoint device. System 100 further includes, in a number of embodiments, a connection to a network-based bulk data-storage system 130, and an administrative web portal 122 that manages each user's account information. In some embodiments, user computer 110, web server 120, and storage system 130 are connected to a network 140, such as the Internet, a local area network (LAN), a wide area network (WAN), or another suitable network. In many embodiments, communications through the network can be through cryptographic communication protocols, such as Secure Socket Layer (SSL) or Transport Layer Security (TLS).

Client software 111 can communicate, for instance, with server component 121 and storage system 130, for example, via network 140. Storage system 130 can include mass storage, such as cloud-based storage offered by a cloud-based service provider, network-based bulk storage, a storage area network (SAN) device, or a network attached storage (NAS) device, as examples, or a combination thereof. In a number of embodiments, storage system 130 is organized hierarchically, for example, first by corporate entity, then by one or more vaults (e.g., 131, 132, and 133). Vaults (e.g., 131, 132, and 133) can each include one or more files that belong to a workgroup for instance. In many embodiments, vaults are organized by directories, subdirectories, and files. A workgroup can include, in various embodiments, a single user or multiple users. Vaults may be accessible only to members of the workgroup and to a company administrator, for example, if the vault is owned by a company on behalf of an employees, contractors, vendors, etc.

In various embodiments, client software 111 can include various modules, which can, for example, each perform various functions. Various modules of client software 111, can, in various embodiments, be separate and discrete, or in other embodiments, the functions of certain modules may be combined with other modules. Client software 111 can include, for example, encryption module 112, file synchronization module 113, management module 114, key management module 115, and file system extension module 116. In various embodiments, encryption module 112 can encrypt files of the workgroup using a first key for the vault. In some embodiments, the first key for the vault is a public key and encryption module 112 encrypts the files of the workgroup using an asymmetric encryption algorithm, such as the RSA algorithm. In other embodiments, the first key for the vault is a symmetric key and encryption module 112 encrypts the files of the workgroup using a symmetric encryption algorithm, such as the AES algorithm. Moreover, in certain embodiments, encryption module 112 further encrypts a second key for the vault that corresponds to the first key for the vault using the personal public key of each member of the workgroup, thus producing an encrypted second key for the vault, so each member of the workgroup can download and decrypt the encrypted second key for the vault and use the second key for the vault to decrypt the files of the workgroup. In embodiments when the first key for the vault is a public key, the second key for the vault can be a private key that corresponds to the first key for the vault, together forming a public-private key pair. In other embodiments when the first key for the vault is a symmetric key, the second key for the vault can be the same symmetric key as the first key for the vault. In various embodiments, encryption module 112 can encrypt the second key for the vault with the personal public key of each member by using, for example, an asymmetric encryption algorithm, such as RSA. Furthermore, in a number of embodiments, encryption module 112 further uses a personal private key of a member of the workgroup, which corresponds to the personal public key of the member to decrypt the encrypted second key for the vault and uses the second key for the vault to decrypt the encrypted files of the workgroup. In various embodiments, together the personal public key of the member and the personal private key of the member form a public-private key pair. Encryption module 112 can decrypt the encrypted second key for the vault with the personal private key of a member by using, for example, an asymmetric encryption algorithm, such as RSA.

In other embodiments, encryption module 112 generates a base symmetric key and encrypts a base computer file using the base symmetric key and a symmetric encryption algorithm (e.g., AES), thus producing an encrypted computer file. The base symmetric key can also be referred to as a session key or simply a symmetric key. The base computer file can be, in some embodiments, an unencrypted computer file. Further, encryption module 112, for example, encrypts the base symmetric key using a first key for the vault, thus producing an encrypted symmetric key. In some embodiments, the first key for the vault is a public key and encryption module 112 encrypts the base symmetric key using an asymmetric encryption algorithm, such as RSA. In other embodiments, the first key for the vault is a symmetric key and encryption module 112 encrypts the base symmetric key using a symmetric encryption algorithm, such as AES. In a number of embodiments, file synchronization module 113 attaches the encrypted symmetric key to the encrypted computer file, and electronically stores the encrypted computer file with the encrypted symmetric key attached to storage system 130 using at least one computer network (e.g., 140). Moreover, in a number of embodiments, encryption module 112, for each member of the workgroup, encrypts a second key for the vault, which corresponds to the first key for the vault, using a personal public key for the member, thus producing an encrypted key for the vault. In various embodiments, encryption module 112 can encrypt the second key for the vault with the personal public key of each member by using, for example, an asymmetric encryption algorithm, such as RSA.

In a number of embodiments, encryption module 112 also, for example, decrypts the encrypted second key for the vault using a personal private key for the member, which corresponds to the personal public key for the member. Together, the personal public key for the member and the personal private key for the member form a public-private key pair. Encryption module 112 can decrypt the encrypted second key for the vault with the personal private key of a member by using, for example, an asymmetric encryption algorithm, such as RSA. Additionally, in certain embodiments, encryption module 112 also decrypts the encrypted symmetric key using the second key for the vault. In embodiments when the second key for the vault is a private key, encryption module 112 can, for example, decrypt the encrypted symmetric key using an asymmetric encryption algorithm, such as RSA. In embodiments when the second key for the vault is a symmetric key, encryption module 112 can, in some embodiments, decrypt the encrypted symmetric key using a symmetric encryption algorithm, such as AES. Moreover, encryption module 112, for instance, decrypts the encrypted computer file using the base symmetric key and, for example, a symmetric encryption algorithm.

In certain further embodiments, encryption module 112 also decrypts the encrypted second key for the vault using a workgroup administrator's personal private key. Furthermore, in particular embodiments, encryption module 112, for each member of a changed workgroup, re-encrypts the second key for the vault using the personal public key for the member, thus producing a new encrypted second key for the vault. Even further, in a number of embodiments, encryption module 112 further electronically stores the encrypted second key for the vault to server component 121 using at least one computer network (e.g., 140).

In some embodiments, key management services 123 is a software interface that communicates with client software 111 and key store database 124, and provides storage and retrieval services for each user's public encryption key and the encrypted second key for each vault. In some embodiments, key store database 124 is a database that maintains encryption keys, including, for example public encryption keys for each user, and encrypted second keys for each vault. In various examples, client software 111, such as encryption module 112, may initiate web service calls to key management services 123 to retrieve or store encryption keys in the key store database.

File system management services 125, in a number of embodiments, is a software interface that communicates with client software 112 and file system database 126 to provide and update file system information about files stored on storage system 130 and the associated workgroups, users, and vaults. In some examples, file system database 126 is a database that maintains all information regarding where a file resides on storage system 130. In specific examples, client software 111, such as file synchronization module 113, may initiate web service calls to file system management services 125 to retrieve or update information about where encrypted files are stored on storage system 130. In additional examples, client software 111, such as file synchronization module 113, may store files to or retrieve files from storage system 130. In further embodiments, administrative web portal 122 allows users to perform administrative functions that do not require cryptographic functions via the internet. For example, administrative functions may include one or more of the creation and deletion of user and corporate accounts, administering billing information, the addition and subtraction of software information, the administration of corporate and person contact information, etc. User account information may, for example, be stored and retrieved from user and account database 127.

In some embodiments, management module 114 provides a client-side management application that allows users to perform management functionality required to administer storage vaults. Key management module 115, in a further embodiment, provides a client-side management application that allows users to perform lifecycle key management, including, for example, key generation, key revocation, key signing, key storage, key retrieval, or other such actions. In various embodiments, file system extension module 116 provides for the extension of the native operating system functionality of user computer 110 to facilitate a seamless user experience, for example. In specific examples, file system extension module 116 provides for an extension of the operating system's shell environment and file systems, for instance, to provide seamless integration of cryptographic functions, key management, and file management.

In many embodiments, client software 111 can manage the membership of a vault and perform cryptographic functions to maintain access to the keys to the vault. These functions can be performed by a user who has the role of vault administrator, for example. In a number of embodiments, all encryption and decryption operations are performed on user computer 110 to prevent unencrypted versions of the second key for the vault from being available on web server 120, on storage system 130, or over network 140, thus providing secure data storage. In various embodiments, file synchronization module 113 monitors for changes in locally decrypted versions of files on user computer 110, re-encrypts the files, and synchronizes the encrypted files back to storage system 130 once they are no longer being actively modified locally on user computer 110, for example, once all file handles have been released on the files.

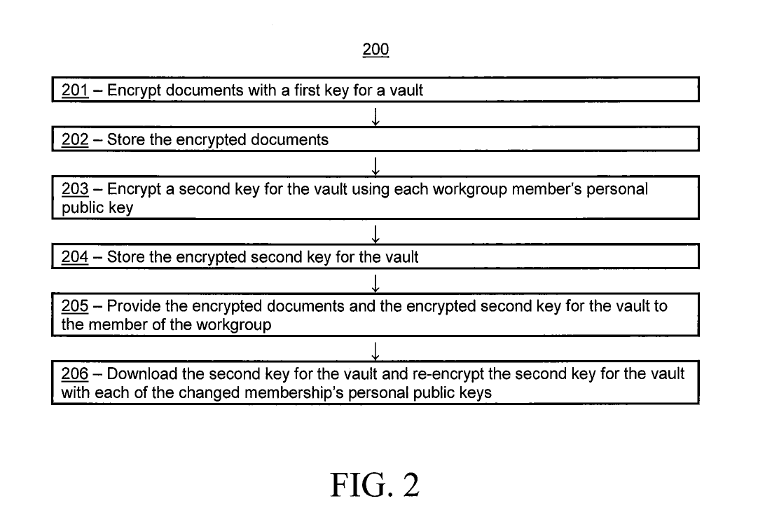

Turning ahead in the drawings, FIG. 2 illustrates various embodiments that include methods implemented by one or more computers, such as user computer 110. Method 200 is an embodiment of a method of securely storing documents electronically for access by members of a workgroup. Method 200 is merely exemplary and the invention is not limited to the embodiments presented herein. The methods can be employed in many different embodiments or examples not specifically depicted or described herein. In some embodiments, the procedures, the processes, and/or the acts of method 200 can be performed in the order presented. In other embodiments, the procedures, the processes, and/or the acts of method 200 can be performed in another suitable order. In still other embodiments, one or more of the procedures, the processes, and/or the acts in method 200 can be combined or skipped.

Various embodiments of such methods can include, for example, (e.g., in various orders) at least certain acts, a number of which are shown as examples. Such acts can include, for instance, an act 201 of (e.g., using at least one computer, such as user computer 110) encrypting the documents with a first key for a vault to produce encrypted documents. In some embodiments, the first key for the vault is a public key, and act 201 of encrypting the documents with the first key for the vault involves encrypting the documents with a public key for the vault to produce the encrypted documents. In those embodiments, for example, encryption module 112 performs encryption of the documents with the first key for the vault using an asymmetric encryption algorithm, such as RSA. In other embodiments, the first key for the vault is a symmetric key, and act 201 of encrypting the documents with the first key for the vault involves encrypting the documents with a symmetric key for the vault to produce the encrypted documents. In those embodiments, for example, encryption module 112 performs encryption of the documents with the first key for the vault by using a symmetric encryption algorithm, such as AES. Such acts (e.g., of method 200) may also include act 202 of electronically storing the encrypted documents, for example, on at least one computer through a computer network. In a specific embodiment, for example, file synchronization module 113 stores the documents to storage system 130 through network 140 and uses web service calls to file system management services 125 to update information in file system database 126.

Such acts may also include, in some embodiments, an act 203 of (e.g., using at least one computer, such as user computer 110) encrypting a second key for the vault that corresponds to the first key for the vault, for example, using each workgroup member's personal public key, to produce an encrypted second key for the vault. In embodiments when the first key for the vault is a public key, the second key for the vault is a private key that corresponds to the first key for the vault, together forming a public-private key pair. In various embodiments, act 203 of encrypting the second key for the vault using each workgroup member's personal public key to produce an encrypted second key for the vault includes encrypting the private key for the vault that corresponds to the public key for the vault using each workgroup member's personal public key to produce an encrypted private key for the vault. In embodiments when the first key for the vault is a symmetric key, the second key for the vault is the same symmetric key as the first key for the vault. In some embodiments, act 203 of encrypting the second key for the vault using each workgroup member's personal public key to produce an encrypted second key for the vault includes encrypting the symmetric key for the vault using each workgroup member's personal public key to produce an encrypted symmetric key for the vault. In specific embodiments, for instance, encryption module 112 encrypts the second key for the vault with the personal public key of each member by using an asymmetric encryption algorithm, such as RSA.

In the embodiment illustrated, method 200 further includes, for instance, an act 204 of electronically storing the encrypted second key for the vault on at least one computer, for example, through the computer network. In a specific embodiment, for example, encryption module 112 uses web service calls through network 140 to key management services 123 to store the encrypted second key for the vault in key store database 124. Method 200 also includes, in the embodiment shown, an act 205 of (e.g., upon request form a member of the workgroup) providing (e.g., through the computer network) the encrypted documents and the encrypted second key for the vault to the member of the workgroup. In a specific embodiment, for example, encryption module 112 uses web service calls through network 140 to key management services 123 to retrieve the encrypted second key for the vault from key store database 124, and file synchronization module 113 uses web service calls to file system management services 125 to access file system information from file system database 126. File synchronization module 113 can then retrieve the encrypted documents through network 140 from storage system 130, for example. The member of the workgroup can then decrypt (e.g., using encryption module 112) the encrypted second key for the vault, for instance, using a personal private key for the member, which corresponds to the member's personal public key. Together, the member's personal public key and personal private key form a public-private key pair. The member of the workgroup can then decrypt (e.g., using encryption module 112) the encrypted documents using the second key for the vault. In this manner, for example, a member of the workgroup can decrypt encrypted documents belonging to the workgroup's vault, even though the file may have originally been encrypted by a different member of the workgroup.

Method 200 can also include, for example, when membership of the workgroup changes and produces changed membership, an act 206 of downloading the encrypted second key for the vault and re-encrypting the second key for the vault with each of the changed membership's personal public keys. Upon changed membership in specific embodiments, for example, a member of the workgroup can use encryption module 112 to make web service calls through network 140 to key management services 123 in order to retrieve the encrypted second key for the vault and the personal public key of each member of the updated workgroup from key store database 124. The member can then, for example, decrypt the encrypted second key for the vault using the member's personal private key. The member of the workgroup can then, for instance, re-encrypt the second key for the vault with the personal public key of each member of the changed workgroup. The member of the workgroup can further, for example, use encryption module 112 to upload the new encrypted second key for the vault to key store database 124. In many embodiments, the set of personal public keys used to re-encrypt the second key for the vault only includes the personal public keys of the new membership of the workgroup, thus preventing removed members from decrypting the encrypted second key for the vault using their personal private keys.

In a number of embodiments, the second key for the vault is encrypted with the personal public key of a workgroup administrator. The workgroup administrator may also have a personal private key corresponding to the workgroup administrator's personal public key, enabling the workgroup administrator to re-encrypt the second key for the vault upon change of membership of the group. In some embodiments, a master public key can be used to encrypt the second key for the vault. In various embodiments, company owners of the master public key have a corresponding master private key, together forming a public-private key pair. The master private key can provide the company owners with the ability to decrypt data files owned by the company, for example, even if individual workgroup members lose their personal private keys.

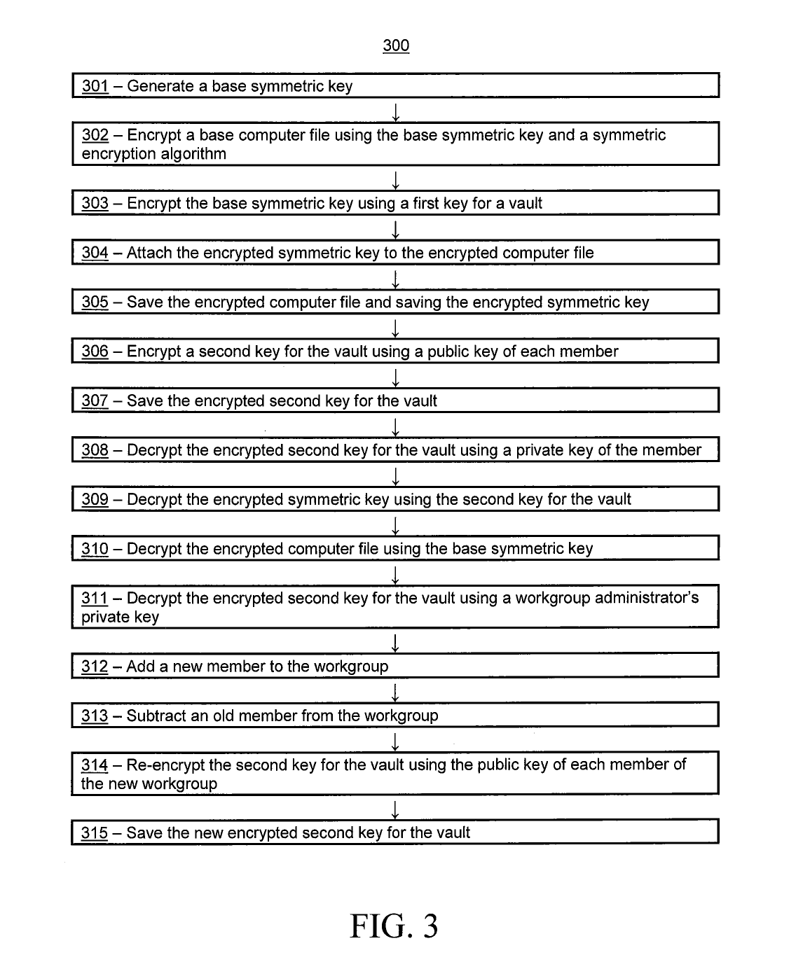

Turning ahead in the drawings, FIG. 3 illustrates a number of embodiments that include methods implemented via execution of computer instructions configured to run at one or more processing modules and configured to be stored at one or more non-transitory memory modules. Method 300 is an embodiment of a method of securely storing computer files for access by members of a workgroup. Method 300 is merely exemplary and the invention is not limited to the embodiments presented herein. The methods can be employed in many different embodiments or examples not specifically depicted or described herein. In some embodiments, the procedures, the processes, and/or the acts of method 300 can be performed in the order presented. In other embodiments, the procedures, the processes, and/or the acts of method 300 can be performed in another suitable order. In still other embodiments, one or more of the procedures, the processes, and/or the acts in method 300 can be combined or skipped.

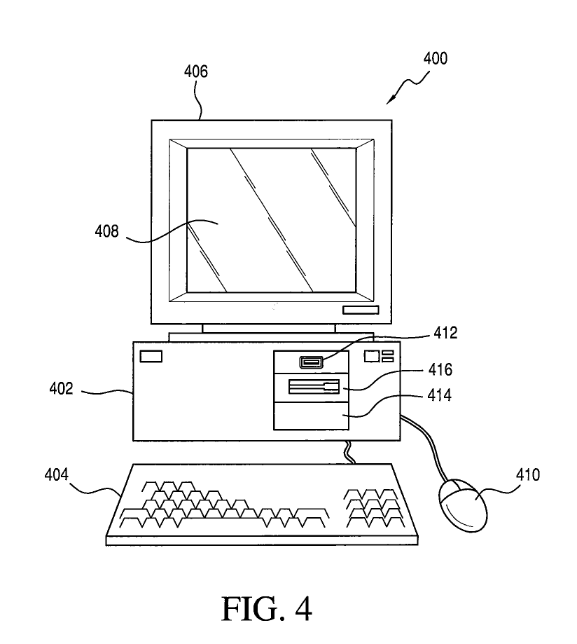

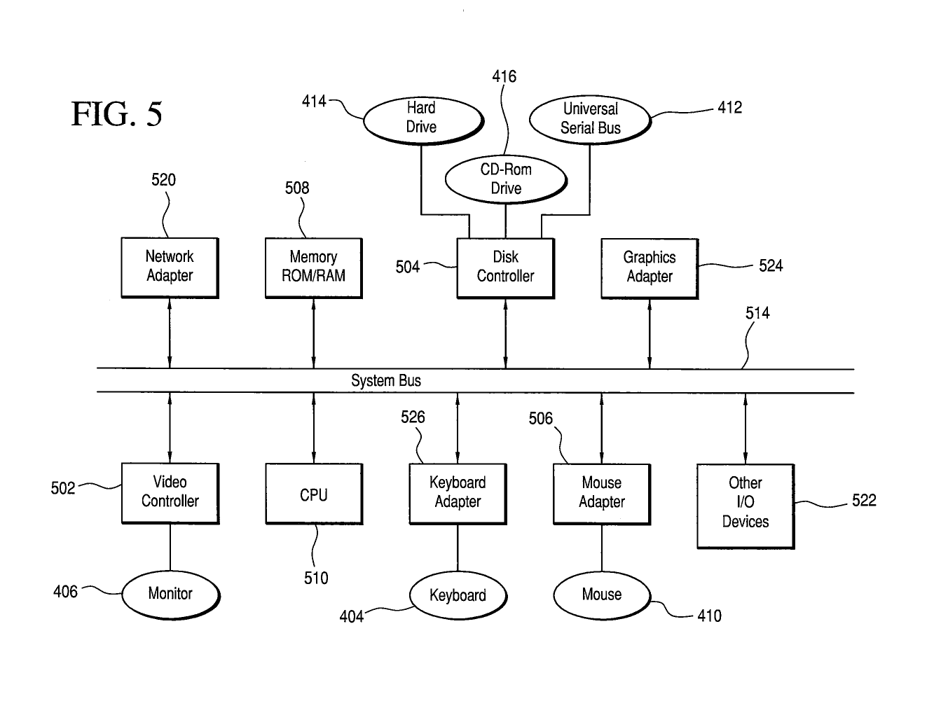

Various embodiments of such methods can include, for example, (e.g., in any order except where a particular order is explicitly indicated) at least certain acts, a number of which are shown as examples. At least part of method 300 can be implemented via execution of computer instructions configured to run at one or more processing modules (e.g., 510 shown in FIG. 5 and described below) and configured to be stored at one or more non-transitory memory modules (e.g., 412, 414, or 416 shown in FIG. 4 and described below). Acts of method 300 can include, for instance, an act 301 of executing a set of one or more computer instructions (e.g., on user computer 110) to generate a base symmetric key. In specific examples, encryption module 112 uses a cryptographically secure pseudo-random number generating algorithm to generate the base symmetric key. Such acts may include, in some embodiments, an act 302 of executing a set of one or more computer instructions to encrypt a base computer file using the base symmetric key and a symmetric encryption algorithm, thus producing an encrypted computer file. In certain embodiments, for example, encryption module 112 uses a symmetric encryption algorithm, such as AES, to encrypt the base computer file using the base symmetric key.

Such acts may include an act 303 of executing a set of one or more computer instructions to encrypt the base symmetric key using a first key for a vault, thus producing an encrypted symmetric key. In some embodiments, the first key for the vault is a public key, and act 303 of encrypting the base symmetric key using the first key for the vault involves encrypting the base symmetric key with a public key for the vault to produce the encrypted symmetric key. In those embodiments, for example, encryption module 112 performs encryption of the base symmetric key with first key for the vault by using an asymmetric encryption algorithm, such as RSA. In other embodiments, the first key for the vault is a symmetric key, and act 303 of encrypting the base symmetric key with the first key for the vault involves encrypting the base symmetric key with a symmetric key for the vault to produce the encrypted documents. In those embodiments, for example, encryption module 112 performs encryption of the base symmetric key with the first key for the vault by using a symmetric encryption algorithm, such as AES.

In the embodiment illustrated, method 300 further includes, for instance, an act 305 of executing a set of one or more computer instructions to save the encrypted computer file and save the encrypted symmetric key. In certain embodiments, for example, encryption module 112 uses web service calls through network 140 to key management services 123 to store the encrypted symmetric key in the key store database. On other specific embodiments, for instance, file synchronization module 113 stores the encrypted symmetric key to storage system 130, for example, in one or more vaults (e.g., 131, 132, and 133). In a number of embodiments, file synchronization module 113 stores the encrypted computer file to storage system 130, for example, in one or more vaults (e.g., 131, 132, and 133). In some embodiments, method 300 can include, for example, an act 304 of executing a set of one or more computer instructions to attach the encrypted symmetric key to the encrypted computer file. In a number of embodiments, for example, act 305 of saving the encrypted computer file and saving the encrypted symmetric key includes executing one or more computer instructions to save the encrypted computer file with the encrypted symmetric key attached. As an example, at least one of encryption module 112 or file synchronization module 113 can attach the encrypted symmetric key to the encrypted computer file, such as by appending the encrypted symmetric key to the end of the encrypted computer file. File synchronization module 113 can then store the encrypted computer file with the encryption symmetric key attached through the network 140 to storage system 130, for example, in one or more vaults (e.g., 131, 132, and 133).

Method 300 can include, for example, an act 306 of executing a set of one or more computer instructions to, for each member of a workgroup, encrypt a second key for the vault, which corresponds to the first key for the vault, using a public key of the member, thus producing an encrypted second key for the vault. In embodiments when the first key for the vault is a public key, the second key for the vault is a private key that corresponds to the first key for the vault, together forming a public-private key pair. In some embodiments, act 306 of encrypting the second key for the vault using each workgroup member's public key includes encrypting the private key for the vault using each workgroup member's public key to produce an encrypted private key for the vault. In embodiments when the first key for the vault is a symmetric key, the second key for the vault is the same symmetric key as the first key for the vault. In various embodiments, act 306 of encrypting the second key for the vault using each workgroup member's public key includes encrypting the symmetric key for the vault using each workgroup member's public key to produce an encrypted symmetric key for the vault. In specific embodiments, for instance, encryption module 112 encrypts the second key for the vault with the public key of each member by using an asymmetric encryption algorithm, such as RSA.

In the embodiment illustrated, method 300 can include, for instance, an act 307 of executing a set of one or more computer instructions to save the encrypted second key for the vault, for example. using at least one network. In a specific embodiment, for instance, encryption module 112 uses web service calls through network 140 to key management services 123 to store the encrypted second key for the vault in key store database 124.

In a number of embodiments, method 300 can include at least certain other acts. Such acts may include an act 308 of executing a set of one or more computer instructions to decrypt the encrypted second key for the vault using a private key of the member. The private key of the member corresponds to the member's personal public key, together forming a public-private key pair. For instance, encryption module 112 decrypts the encrypted second key for the vault with the private key of the member using an asymmetric encryption algorithm, such as RSA. Method 300 can further include, in a number of embodiments, an act 309 of executing a set of one or more computer instructions to decrypt the encrypted symmetric key using the second key for the vault. In embodiments where the second key for the vault is a private key, encryption module 112 can, for example, decrypt the encrypted symmetric key with the private key for the vault by using an asymmetric encryption algorithm, such as RSA. In embodiments where the second key for the vault is a symmetric key, encryption module 112 can, for example, decrypt the encrypted symmetric key with the symmetric key for the vault by using a symmetric encryption algorithm, such as AES. Method 300 can still further include an act 310 of executing a set of one or more computer instructions to decrypt the encrypted computer file using the base symmetric key. Encryption module 112, for example, can decrypt the encrypted computer file with the base symmetric key by using a symmetric encryption algorithm, such as AES.

In some embodiments, method 300 further provides a process of changing membership of the workgroup. The method includes (e.g., in any order) at least certain acts. In some embodiments, such acts may include an act of executing one or more computer instructions to retrieve the encrypted second key for the vault. For example, encryption module 112 can make web service calls through network 140 to key management services 123 to retrieve the encrypted second key for the vault from key store database 124. Such acts can include an act 311 of executing a set of one or more computer instructions to decrypt the encrypted second key for the vault using a workgroup administrator's private key. For instance, encryption module 112 can decrypt the encrypted second key for the vault with the workgroup administrator's private key using an asymmetric encryption algorithm, such as RSA.

The process of changing membership of the workgroup, as illustrated in method 300, can include an act 312 of executing a set of one or more computer instructions to add a new member to the workgroup. Adding a member to the workgroup can include, among other things, adding the new member's public key to the set of public keys of the workgroup members stored in key store database 124. Method 300 can include an act 313 of executing a set of one or more computer instructions to subtract an old member from the workgroup. Subtracting a member from the workgroup can include, among other things, removing the old member's public key from the set of public keys of the workgroup members stored in key store database 124. In various embodiments of the process of changing membership of the workgroup, method 300 can include an act of retrieving the public key of each member of the workgroup. For example, client software 111 can make web service calls through network 140 to key management services 123 to retrieve the public key of each member of the workgroup from key store database 124.

Method 300 can further include, in various embodiments, an act 314 of re-encrypting the second key for the vault using the public key of each member of the workgroup, for example, including the new member and/or not including the old member, thus producing a new encrypted second key for the vault. As an example, encryption module 112 can re-encrypt the second key for the vault with the public key of each member by using an asymmetric encryption algorithm, such as RSA. In many embodiments, the set of public keys used to re-encrypt the second key for the vault only includes the personal public keys of the new membership of the workgroup, thus preventing removed members from decrypting the encrypted second key for the vault using their personal private keys, but allowing new members to decrypt the encrypted second key for the vault using their personal private keys. Some embodiments of such methods include an act 315 of executing a set of one or more computer instructions to save the new encrypted second key for the vault using at least one computer network. For instance, encryption module can make web service calls through network 140 to key management services 123 to store the new encrypted second key for the vault to key store database 124.

Turning ahead again in the drawings, FIG. 4 illustrates an exemplary embodiment of computer system 400, all of which or a portion of which can be suitable for implementing an embodiment of user computer 110 (FIG. 1) and/or any of various other elements of system 100 (FIG. 1), as well as any of the various procedures, processes, and/or acts of method 200 (FIG. 2) or method 300 (FIG. 3). As an example, a different or separate one of chassis 402 (and its internal components) can be suitable for implementing computer system 110 (FIG. 1), etc. Furthermore, one or more elements of computer system 400 (e.g., refreshing monitor 406, keyboard 404, and/or mouse 410, etc.) can also be appropriate for implementing computer system 110 (FIG. 1). Computer system 400 comprises chassis 402 containing one or more circuit boards (not shown), Universal Serial Bus (USB) port 412, Compact Disc Read-Only Memory (CD-ROM) and/or Digital Video Disc (DVD) drive 416, and hard drive 414. A representative block diagram of the elements included on the circuit boards inside chassis 402 is shown in FIG. 5. Central processing unit (CPU) 510 in FIG. 5 is coupled to system bus 514 in FIG. 5. In various embodiments, the architecture of CPU 510 can be compliant with a variety of commercially distributed architecture families.

Continuing with FIG. 5, system bus 514 also is coupled to memory storage unit 508, where memory storage unit 508 comprises both read only memory (ROM) and random access memory (RAM). Non-volatile portions of memory storage unit 508 or the ROM can be encoded with a boot code sequence suitable for restoring computer system 400 (FIG. 4) to a functional state after a system reset. In addition, memory storage unit 508 can comprise microcode such as a Basic Input-Output System (BIOS). In some examples, the one or more memory storage units of the various embodiments disclosed herein can comprise memory storage unit 508, a USB-equipped electronic device, such as, an external memory storage unit (not shown) coupled to universal serial bus (USB) port 412 (FIGS. 4-5), hard drive 414 (FIGS. 4-5), and/or CD-ROM or DVD drive 416 (FIGS. 4-5). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or another type of processor or processing circuit capable of performing the desired functions. In some examples, the one or more processors of the various embodiments disclosed herein can comprise CPU 510.

In the depicted embodiment of FIG. 5, various I/O devices such as disk controller 504, graphics adapter 524, video controller 502, keyboard adapter 526, mouse adapter 506, network adapter 520, and other I/O devices 522 can be coupled to system bus 514. Keyboard adapter 526 and mouse adapter 506 are coupled to keyboard 404 (FIGS. 4-5) and mouse 410 (FIGS. 4-5), respectively, of computer system 400 (FIG. 4). While graphics adapter 524 and video controller 502 are indicated as distinct units in FIG. 5, video controller 502 can be integrated into graphics adapter 524, or vice versa in other embodiments. Video controller 502 is suitable for refreshing monitor 406 (FIGS. 4-5) to display images on a screen 408 (FIG. 4) of computer system 400 (FIG. 4). Disk controller 504 can control hard drive 414 (FIGS. 4-5), USB port 412 (FIGS. 4-5), and CD-ROM drive 416 (FIGS. 4-5). In other embodiments, distinct units can be used to control each of these devices separately.

Although many other components of computer system 400 (FIG. 4) are not shown, such components and their interconnection are well known to those of ordinary skill in the art. Accordingly, further details concerning the construction and composition of computer system 400 and the circuit boards inside chassis 402 (FIG. 4) are not discussed herein.

When computer system 400 in FIG. 4 is running, program instructions stored on a USB-equipped electronic device connected to USB port 412, on a CD-ROM or DVD in CD-ROM and/or DVD drive 416, on hard drive 414, or in memory storage unit 508 (FIG. 4) are executed by CPU 510 (FIG. 4). A portion of the program instructions, stored on these devices, can be suitable for carrying out at least part of system 100 (FIG. 1) as well as any of the various procedures, processes, and/or acts of method 200 (FIG. 2) and method 3 (FIG. 3).

Although computer system 400 is illustrated as a desktop computer in FIG. 4, there can be examples where computer system 400 may take a different form factor while still having functional elements similar to those described for computer system 400. In some embodiments, computer system 400 may comprise a single computer (e.g., a personal computer, a notebook computer, a workstation, a handheld computer such as a personal digital assistant, a mobile phone, a smart phone, etc.), a single server, or a cluster or collection of computers or servers, or a cloud of computers or servers. Typically, a cluster or collection of servers can be used when the demand on computer system 400 exceeds the reasonable capability of a single server or computer. In many embodiments, computer system 110 (FIG. 1) can comprise a single server, or a cluster or collection of computers or servers, or a cloud of computers or servers.

Although the invention has been described with reference to specific embodiments, it will be understood by those skilled in the art that various changes may be made without departing from the scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that acts 201-206 of FIG. 2 and act 301-315 of FIG. 3 may be comprised of many different procedures, processes, and acts and be performed by many different modules, in many different orders, that any element of FIGS. 1-5 may be modified, and that the foregoing discussion of certain of these embodiments does not necessarily represent a complete description of all possible embodiments.

What is claimed is:

1. A computer-implemented method of securely storing documents electronically for access by members of a workgroup, the method comprising, in any order except where a particular order is explicitly indicated, at least the acts of:
using at least one computer, encrypting the documents with a first key for a vault, thereby producing encrypted documents;
electronically storing the encrypted documents on at least one computer through a computer network;
encrypting a second key for the vault that corresponds to the first key for the vault using each workgroup member's personal public key, thereby producing an encrypted second key for the vault;
electronically storing the encrypted second key for the vault on at least one computer through the computer network;
upon request from a member of the workgroup, providing, through the computer network, the encrypted documents and the encrypted second key for the vault to the member of the workgroup, so the member of the workgroup can decrypt the encrypted second key for the vault using a personal private key for the member, which corresponds to the member's personal public key, and decrypt the encrypted documents using the second key for the vault; and
when membership of the workgroup changes, thereby producing changed membership, downloading the encrypted second key for the vault and re-encrypting the second key for the vault with each of the changed membership's personal public keys.

2. The computer-implemented method of claim 1 wherein:
the first key for the vault is a public key, and the act of encrypting the documents with the first key for the vault comprises encrypting the documents with the public key for the vault, thereby producing the encrypted documents;
the second key for the vault is a private key that corresponds to the first key for the vault, and the act of encrypting the second key for the vault that corresponds to the first key for the vault using each workgroup member's personal public key, thereby producing an encrypted second key for the vault comprises encrypting the private key for the vault that corresponds to the public key for the vault using each workgroup member's personal public key, thereby producing an encrypted private key for the vault;

3. The computer-implemented method of claim 1 wherein:
the first key for the vault is a symmetric key, and the act of encrypting the documents with the first key for the vault comprises encrypting the documents with the symmetric key for the vault, thereby producing the encrypted documents; and
the second key for the vault is the first key for the vault, and the act of encrypting the second key for the vault that corresponds to the first key for the vault using each workgroup member's personal public key, thereby producing an encrypted second key for the vault comprises encrypting the symmetric key for the vault using each workgroup member's personal public key, thereby producing an encrypted symmetric key for the vault.

4. A method of securely storing computer files for access by members of a workgroup, at least part of the method being implemented via execution of computer instructions configured to run at one or more processing modules and configured to be stored at one or more non-transitory memory modules, the method comprising, in any order except where a particular order is explicitly indicated, at least the acts of:
executing a set of one or more computer instructions to generate a base symmetric key;
executing a set of one or more computer instructions to encrypt a base computer file using the base symmetric key and a symmetric encryption algorithm, thereby producing an encrypted computer file;
executing a set of one or more computer instructions to encrypt the base symmetric key using a first key for a vault, thereby producing an encrypted symmetric key;
executing a set of one or more computer instructions to save the encrypted computer file and save the encrypted symmetric key;
executing a set of one or more computer instructions to, for each member of a workgroup, encrypt a second key for the vault, which corresponds to the first key for the vault, using a public key of the member, thereby producing an encrypted second key for the vault; and
executing a set of one or more computer instructions to save the encrypted second key for the vault using at least one network.

5. The method of claim 4 further comprising at least the act of executing a set of one or more computer instructions to attach the encrypted symmetric key to the encrypted computer file, and wherein the act of executing the set of one or more computer instructions to save the encrypted computer file and save the encrypted symmetric key comprises executing a set of one or more computer instructions to save the encrypted computer file with the encrypted symmetric key attached.

6. The method of claim 4 further comprising, in the following order, at least the acts of:
executing a set of one or more computer instructions to decrypt the encrypted second key for the vault using a private key of the member;
executing a set of one or more computer instructions to decrypt the encrypted symmetric key using the second key for the vault; and
executing a set of one or more computer instructions to decrypt the encrypted computer file using the base symmetric key.

7. The method of claim 4 further comprising, after performing all of the acts of claim 4, a process of changing membership of the workgroup, the process of changing membership comprising in any order at least the acts of:
executing a set of one or more computer instructions to decrypt the encrypted second key for the vault using a workgroup administrator's private key;
executing a set of one or more computer instructions to add a new member to the workgroup;
executing a set of one or more computer instructions to re-encrypt the second key for the vault using the public key of each member of the workgroup, including the new member, thereby producing a new encrypted second key for the vault; and
executing a set of one or more computer instructions to save the new encrypted second key for the vault using at least one computer network.

8. The method of claim 4 further comprising, after performing all of the acts of claim 4, a process of changing membership of the workgroup, the process of changing membership comprising in any order at least the acts of:
executing a set of one or more computer instructions to decrypt the encrypted second key for the vault using a workgroup administrator's private key;
executing a set of one or more computer instructions to subtract an old member from the workgroup;
executing a set of one or more computer instructions to re-encrypt the second key for the vault, which corresponds to the first key for the vault, using the public key of each member of the workgroup, not including the old member, thereby producing a new encrypted second key for the vault; and
executing a set of one or more computer instructions to save the new encrypted second key for the vault using at least one computer network.

9. A system for providing secure data storage, the system comprising:
a server component, running on at least one web server, that hosts web services backed by databases, wherein the server component performs user authentication, key management, and maintenance of information regarding the location of user owned encrypted files for multiple users that are members of at least one vault that houses the encrypted files;
client software, that, when installed on a user computer, handles cryptographic actions, workgroup management actions, and storage and retrieval actions;
a connection to a network-based bulk data-storage system; and
an administrative web portal that manages each user's account information.

10. The system of claim 9 wherein the client software comprises an encryption module that encrypts files of the workgroup using a first key for the vault.

11. The system of claim 10 wherein the encryption module further encrypts a second key for the vault that corresponds to the first key for the vault using the personal public key of each member of the workgroup, thereby producing an encrypted second key for the vault, so each member of the workgroup can download and decrypt the encrypted second key for the vault and use the second key for the vault to decrypt the files of the workgroup.

12. The system of claim 11 wherein the encryption module further uses a personal private key of a member of the workgroup, which corresponds to the personal public key of the member, to decrypt the encrypted second key for the vault and uses the second key for the vault to decrypt the encrypted files of the workgroup.

13. The system of claim 9 wherein the client software comprises an encryption module that:
generates a base symmetric key;
encrypts a base computer file using the base symmetric key and a symmetric encryption algorithm, thereby producing an encrypted computer file;
encrypts the base symmetric key using a first key for the vault, thereby producing an encrypted symmetric key; and
for each member of the workgroup, encrypts a second key for the vault, which corresponds to the first key for the vault, using a personal public key for the member, thereby producing an encrypted second key for the vault.

14. The system of claim 13 wherein the encryption module further:
decrypts the encrypted second key for the vault using a personal private key for the member, which corresponds to the personal public key for the member;
decrypts the encrypted symmetric key using the second key for the vault; and
decrypts the encrypted computer file using the base symmetric key.

15. The system of claim 14 wherein the encryption module further:
decrypts the encrypted second key for the vault using a workgroup administrator's personal private key; and
for each member of a changed workgroup, re-encrypts the second key for the vault using the personal public key for the member, thereby producing a new encrypted second key for the vault.

16. The system of claim 15 wherein the encryption module further electronically stores the encrypted second key for the vault to the server component using at least one computer network.

17. The system of claim 16 wherein the client software further comprises a file synchronization module that:
attaches the encrypted symmetric key to the encrypted computer file; and
electronically stores the encrypted computer file with the encrypted symmetric key attached to the network-based bulk data-storage system using at least one computer network.

18. The system of claim 17 wherein:
the first key for the vault is a public key for the vault;
the second key for the vault that corresponds to the first key for the vault is a private key for the vault that corresponds to the public key for the vault; and
the encrypted second key for the vault is an encrypted private key for the vault.

19. The system of claim 17 wherein:
the first key for the vault is a symmetric key for the vault; and
the second key for the vault is the first key for the vault.
